(19) United States
(12) Patent Application Publication
(10) Pub. No.: US 2008/0139261 A1
(43) Pub. Date: Jun. 12, 2008

(54) Magnetic levitation sliding structure

(75) Inventors: Se-hoon Cho, Gwangju-si (KR); Jong-Soon Kim, Gimhae-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/891,985

(22) Filed: Aug. 14, 2007

(30) Foreign Application Priority Data
Dec. 7, 2006 (KR) 10-2006-0124089

(51) Int. Cl. H04M 1/02; H01F 7/02

(52) U.S. Cl. 455/575.4; 335/285; 335/306

(57) ABSTRACT

A magnetic levitation sliding structure is provided. The sliding structure includes a first slider member including a guide portion with a first magnet, a second slider member including a receiving portion with a channel-shaped second magnet, the receiving portion being configured to receive the guide portion so as to slide on the first slider member. The first and second magnets are configured so that a repelling force can act there between for facilitating the sliding operation. In some embodiments the sliding structure includes at least one attraction member configured at an initial and/or final position of one of the first and second slider members. A portable electronic device including the magnetic levitation sliding structure is also provided.

### CROSS-REFERENCE TO RELATED PATENT APPLICATION

This application claims the benefit of Korean Patent Application No. 10-2006-0124089, filed on Dec. 7, 2006, in the Korean Intellectual Property Office, the disclosure of which is incorporated herein in its entirety by reference.

### BACKGROUND OF THE INVENTION

1. Field of the Invention

The present invention relates generally to a sliding structure, and more particularly, to a magnetic levitation sliding structure.

2. Description of the Related Art

Due to their simple handling and attractive design, sliding structures have been used in portable electronic devices such as cellular phones, cameras, portable multimedia players (PMP) or the like.

FIG. 1A is a perspective view illustrating a conventional cellular phone 10. FIG. 1B is a schematic partial see-through side view illustrating the conventional cellular phone 10 of FIG. 1A and a sliding structure 40 thereof.

Referring to FIGS. 1A and 1B, the conventional cellular phone 10 having the sliding structure 40 further includes a receiver portion 20 including a display portion 2 and a transmitter portion 30 including a handling portion 3 such as number key buttons or the like. In order to use the conventional cellular phone 10, the receiver portion 20 is pushed upwardly relative to the transmitter unit 30 (or vice versa) via the sliding structure 40.

Referring to FIG. 1B, the conventional sliding structure 40, which is disclosed in Korean Patent Publication No. 10-2005-0037649, includes a first slider member 41 and a second slider member 42 that slides on or relative to the first slider member 41.

The first slider member 41 includes a first magnet 43 and the second slider member 42 includes a pair of second magnets 44a and 44b, so that a sliding operation is assisted by a magnetic force.

In the conventional sliding structure 40, friction between the first slider member 41 and the second slider member 42 impedes the sliding operation. In particular, the friction between the first slider member 41 and the second slider member 42 increases during a sliding operation due to the attraction force between the first magnet 43 and the pair of second magnets 44a and 44b. Accordingly, it may be difficult for a user to operate the conventional cellular phone 10.

FIG. 1C is a view illustrating another conventional sliding structure 50. Referring to FIG. 1C, the sliding structure 50, disclosed in Korean Patent Publication No. 10-2005-0089584, includes a first slider member 51 and a second slider member 52 that slides on or relative to the first slider member 51.

The first slider member 51 includes a first magnet 53 having a generally horseshoe shaped, C-shaped or sideways U-shaped cross-section, and the second slider member 52 includes a second magnet 54 that has a shape similar to that of the first magnet 53. The first magnet 53 and the second magnet 54 are alternately arranged (i.e., an arm of one magnet is configured in a channel of the other magnet and vice versa) to facilitate a sliding operation.

In the sliding structure 50, repelling forces operate between the N pole of the first magnet 53 and the N pole of the second magnet 54, and between the S pole of the first magnet 53 and the S pole of the second magnet 54 so that a sliding operation can be performed. Simultaneously, an attraction force also operates between the S pole of the first magnet 53 and the N pole of the second magnet 54. Accordingly, a sliding operation does not proceed smoothly since a greater force is required to push the sliding structure 50 to overcome the attraction between the first magnet 53 and the second magnet 54.

In addition, in the sliding structure 50, since the first magnet 53 and the second magnet 54, which have horseshoe shapes, are alternately arranged, a large space for such arrangement is required, and thus the thickness of the sliding structure 50 is increased. Also, in curved parts on which parts of the first magnetic member 53 and the second magnetic member 54 are not overlapped, since a repelling force between the parts of the first magnetic member 53 and the second magnetic member 54 is reduced, the sliding operation can not be easily performed.

### SUMMARY OF THE INVENTION

According to an aspect of the present invention, there is provided a magnetic levitation sliding structure comprising: a first slider member including a guide portion; a second slider member including a receiving portion that has a complementary shape to the guide portion and slidably mates therewith; a first magnet coupled with the guide portion and being configured along a central portion thereof; and a generally channel-shaped second magnet coupled with the receiving portion, wherein the first magnet is configured in the channel of the second magnet to facilitate relative sliding movement of the first and second slider members.

The sliding structure may further comprise auxiliary receiving portions extending from both sides of the first slider member and each receiving a part of the receiving portion. The auxiliary receiving portions may have a generally L-shaped cross-sectional shape such that the guide portions are substantially enclosed.

The sliding structure may further comprise magnetic shields configured on one or more of the guide portion, the receiving portion and one or more surfaces of the first and second magnets.

The receiving portion may have a generally J-shaped cross-sectional shape.

The channel-shaped second magnet portion may have a generally horseshoe shaped, C-shaped or sideways U-shaped cross-section shape.

The sliding structure may further comprise at least one ferromagnetic member coupled with the guide portion and spaced apart from the first magnet in a direction parallel to a sliding direction. The at least one ferromagnetic member may include two ferromagnetic members such that the first magnet may be configured between a pair of ferromagnetic members.

The sliding structure may further comprise at least one edge magnet coupled with the guide portion and spaced apart from the first magnet in a direction parallel to a sliding direction. The at least one edge magnet may include two ferromagnetic members such that the first magnet may be configured between a pair of edge magnets. The magnetic poles of each of the edge magnets may be arranged in the order opposite to that of the magnetic poles of the first magnet.

The first magnet and the second magnet may be configured so that an imaginary line, which is perpendicular to the lengths of the first and second magnets and which connects facing surfaces of the channel walls of the second magnet, can pass through at least a part of the first magnet during a sliding operation.

### BRIEF DESCRIPTION OF THE DRAWINGS

FIG. 1A is a perspective view illustrating a conventional cellular phone having a sliding structure;

FIG. 1B is a partial see-through side view illustrating the conventional cellular phone of FIG. 1A;

FIG. 1C is a cross-sectional view illustrating another conventional sliding structure;

FIG. 2 is a partially-exploded perspective view of a sliding structure according to an embodiment of the present invention;

FIG. 3 is a cross-sectional view of the sliding structure of FIG. 2 taken along line III-III;

FIG. 4 is a perspective view illustrating a configuration of a first magnet unit and a second magnet unit of the sliding structure of FIG. 2;

FIG. 5 is a perspective view illustrating an assembled view of the sliding structure of FIG. 2 with the second slider member being oriented at an initial position;

FIG. 6 is a cross-sectional view of the sliding structure of FIG. 5 taken along line VI-VI;

FIG. 7 is a perspective view illustrating an assembled view of the sliding structure of FIG. 2 with the second slider member being oriented at an intermediate position;

FIG. 8 is a cross-sectional view of the sliding structure of FIG. 7 taken along line VIII-VIII;

FIG. 9 is a perspective view illustrating an assembled view of the sliding structure of FIG. 2 with the second slider member being oriented at a final position;

FIG. 10 is a cross-sectional view of the sliding structure of FIG. 9 taken along line X-X;

FIG. 11 is a partially-exploded perspective view illustrating a sliding structure, according to another embodiment of the present invention;

FIG. 12 is a cross-sectional view of the sliding structure of FIG. 11 taken along line XII-XII;

FIG. 13 is a cross-sectional view of the sliding structure of FIG. 11 taken along line XIII-XIII;

FIG. 14 is a perspective view illustrating a configuration of a first magnet unit and a second magnet unit of the sliding structure of FIG. 11;

FIG. 15 is a perspective view illustrating a sliding structure, according to yet another embodiment of the present invention;

FIG. 16 is a cross-section view of the sliding structure of FIG. 15 taken along line XVI-XVI of FIG. 15;

FIG. 17 is a cross-section view of the sliding structure of FIG. 15 taken along line XVII-XVII of FIG. 15; and

FIG. 18 is a perspective view illustrating a configuration of magnets in the sliding structure of FIG. 15.

### DETAILED DESCRIPTION OF THE EMBODIMENTS

The present invention will now be described more fully with reference to the accompanying drawings, in which exemplary embodiments of the invention are shown.

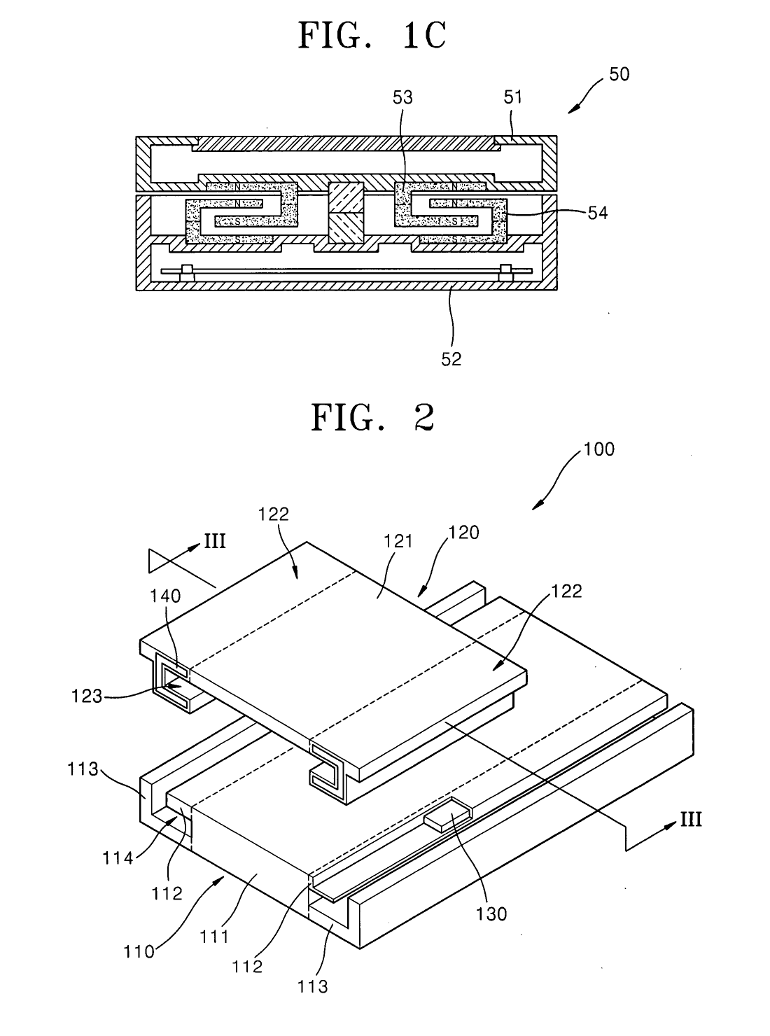

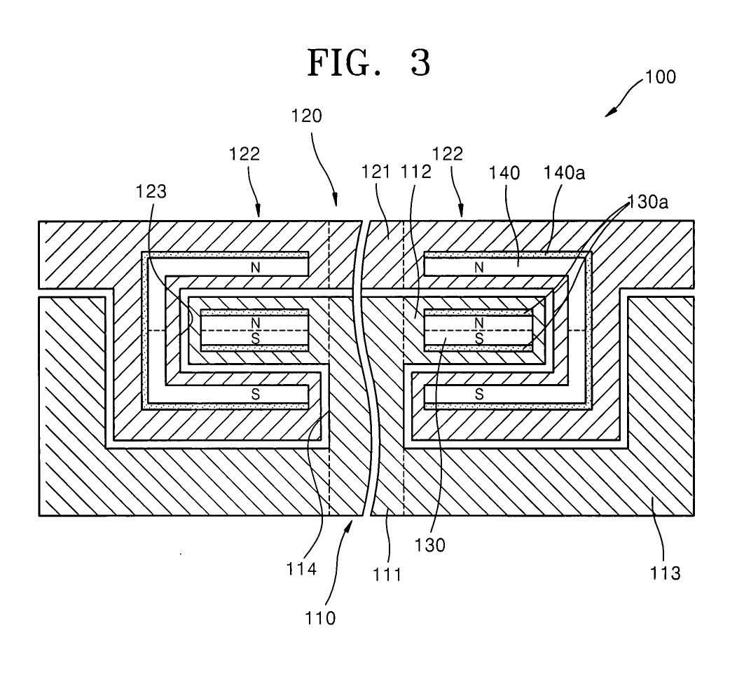

Referring to FIGS. 2 and 3, a sliding structure 100 for a mobile electronic device includes a first slider member 110 with first magnets 130; and a second slider member 120 with second magnets 140. Hereinafter, although the sliding structure 100 is described in operation with the first slider member 110 being relatively stationary and the second slider member 120 sliding on the first slider member 110, it should be appreciated that the first and second slider member 110, 120 move relative to each other. To this end, the sliding structure 100 may be operated by holding the second slider member 120 generally stationary and sliding the first slider member 110 on the second slider member 120. Furthermore, it should be appreciated that the terms up, upward, down, downward, top, bottom, right and left are used herein for sake of convenience of description and are not intended as limiting the present sliding structure 100 to a particular orientation, configuration or operation. Moreover, since the sliding structures 100, 200 shown and described herein are substantially right-left, mirror-image symmetric, only one side of the structures 100, 200 will be described for brevity.

The first slider member 110 is formed of a non-magnetic material (e.g., aluminium alloy, plastic, synthetic resin, etc.) and includes a support portion 111, guide portions 112, and auxiliary receiving portions 113.

The support portion 111 has a generally rectangular parallelepiped shape. The guide portions 112 extend outward from both sides of the support portion 111 such that the upper surfaces of the guide portions 112 are substantially coplanar with the top surface of the support portion 111. The guide portions 112 extend along substantially an entire length of the support portion 111.

The auxiliary receiving portions 113 extend outward from the sides of the support portion 111 past the outward edges of the guide portions 112 and then the auxiliary receiving portions 113 extend upward toward the guide portions 112 so that the auxiliary receiving portions 113 have generally L-shaped cross-sections. Bottom surfaces of the auxiliary receiving portions 113 are substantially coplanar with the bottom surface of the support portion 111 so that each of the auxiliary receiving portions 113 is spaced by a predetermined distance from each of the proximate guide portions 112. The auxiliary receiving portions 113 extend along substantially an entire length of the support portion 111. According to the configuration of the guide portions 112 and the auxiliary receiving portions 113, first receiving grooves 114 are defined on right and left sides of the support portion 111.

While the auxiliary receiving portions 113 extend outward and upward from right and left sides of the support portion 111 in FIGS. 2 and 3, the present embodiment is not limited thereto. That is, the auxiliary receiving portions 113 may extend from the bottom surface of the support portion 111 or be configured otherwise.

The support portion 111, the guide portion 112, and the auxiliary receiving portion 113 may be manufactured by various methods known in the art. For example, they may be manufactured by die casting or by bending a plate-shaped material and making the bent plate-shaped material subjected to plastic deformation. Additionally, they may be otherwise formed or molded so that the portions 111, 112, 113 are integral or unitary.

The second slider member 120 may be formed of a non-magnetic material (e.g., aluminium alloy, plastic, synthetic resin, etc.) and includes a base portion 121 and receiving portions 122. The second slider member 120 may be made of the same or of a different material as the first slider member 110. As shown in FIGS. 2 and 4-10, the second slider member 120 has a length that is approximately half the length of the first slider member 110. However, the second slider member 120 may be configured otherwise.

The base portion 121 has a generally planar shape. The receiving portions 122 extend from both sides of the base portion 121. The receiving portions 122 extend along substantially an entire length of the base portion 121.

The receiving portions 122 are configured to have complementary shapes to slidably mate with the guide portions 112 (and, optionally, the auxiliary receiving portions 113) of the first slide member 110. As shown, the receiving portions 122 have generally J-shaped cross-sections such that a second receiving groove 123 is defined inside the receiving portion 122. As can be appreciated, the guide portion 112 is inserted into the second receiving groove 123 when the sliding structure 100 is assembled. Furthermore, a part of the receiving portion 122 is inserted into the first receiving groove 114 when the sliding structure 100 is assembled. In this way, the receiving portions 122 and guide portions 112 guide relative sliding movement of the slider members 110, 120.

The base portion 121 and the receiving portions 122 may be manufactured by various methods known in the art. For example, the base portion 121 and the receiving portions 122 may be manufactured by die casting or by bending a plate-shaped material and making the bent plate-shaped material subjected to plastic deformation. Additionally, they may be otherwise formed or molded so that the portions 121, 122 are integral or unitary.

To further reduce friction between the members 110, 120 of the sliding structure 100, a lubricant may be coated on surfaces of the guide portions 112, inner surfaces of the receiving portions 122, and inner surfaces of the auxiliary receiving portions 113 where contact may occur during the sliding operation. For example, a ceramic material may be coated on the surfaces where the contacts may occur during the sliding operation. Alternatively, one or more of the guide portions 112, auxiliary receiving portions 113 and receiving portions 122 may be made of a material (e.g., plastic, ceramic, glass, etc.) having inherent lubricity.

Each of the first magnets 130 is coupled with a guide portion 112. As is best illustrated in FIGS. 2, 4, 6, 8 and 10, the first magnet 130 is configured at a middle position of a sliding stroke of the guide portion 112 (i.e., in a central portion of the guide portion 112, spaced away from the ends thereof) such that the first magnet 130 extends through about half a length of the guide portion 112 (and support portion 111). However, the first magnet 130 may be configured otherwise, for example, offset from a central portion of the guide portion 112 and/or extending further toward one or more of the ends of the guide portion 112 for facilitating sliding movement.

While the first magnet 130 is a permanent magnet, the present embodiment is not limited thereto. That is, the first magnet 130 may be one or more electromagnets.

Although the first magnet 130 is substantially enclosed in or otherwise configured in the guide portion 112 as shown in FIGS. 2 and 3, the present embodiment is not limited thereto. That is, the first magnet 130 may be configured on one or more surfaces of the guide portion 112.

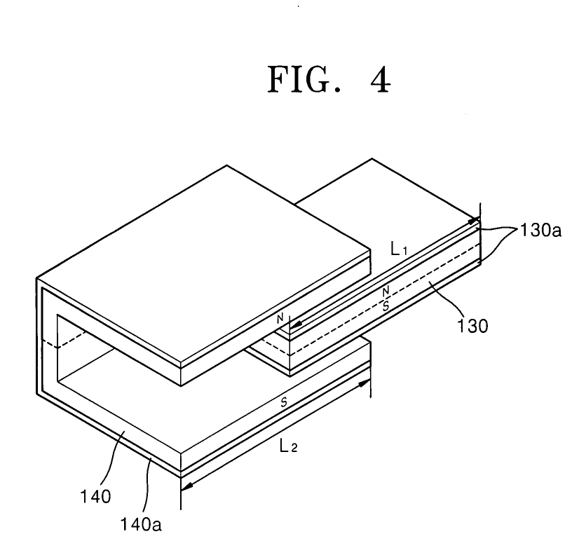

Referring to FIG. 4, the length L₁ of the first magnet 130 is substantially similar as the length L₂ of the second magnet 140. However, the present embodiment is not limited thereto. That is, the length L₁ of the first magnet 130 is not limited to being substantially similar as the length L₂.

The first magnet 130 may have a rectangular parallelepiped shape, and magnetic poles of the first magnet 130 are arranged so as to be perpendicular to a sliding direction (i.e., the sliding direction being defined by an axis that is generally parallel to the length of the first slide member 110). Further, the first magnet 130 is arranged so that the N pole and the S pole correspond to an upper part (i.e., facing the second slide member 120) and a lower part (i.e., facing away from the second slide member 120), respectively, but the present invention is not limited thereto. That is, the first magnet 130 may be arranged so that the N pole and the S pole may correspond to the lower part and the upper part thereof, respectively. In such case, the channel wall portions of the second magnet 140 corresponding to or otherwise proximate to the first magnet 130 may be arranged oppositely to the illustrated configuration so that the poles thereof are configured to repel the magnetic poles of the first magnet 130.

A magnetic shield 130a, for shielding the magnetic force lines, may be configured on the upper and lower parts of the first magnet 130, but the present invention is not limited thereto. That is, the magnetic shield 130a may be additionally or alternatively configured on one or more end or side surfaces of the first magnet 130. In addition, the magnetic shield 130a may be configured on a part of the guide portion 112 in which the first magnet 130 may be enclosed. In such case, the magnetic shield 130a may be placed on an appropriate part of the guide portion 112, and then the first magnet 130 may be inserted into or otherwise configured in the guide portion 112.

The magnetic shield 130a may be formed of a ferromagnetic substance, such as an AD-MU alloy or the like, but the present invention is not limited thereto. Thus is, the magnetic shield 130a may be formed of a non-magnetic substance.

The second magnets 140 are coupled with the receiving portions 122.

The second magnet 140 may be a permanent magnet, an electromagnet, or the like. Also, although the second magnet 140 is substantially enclosed in or otherwise configured in the receiving portion 122 as shown in FIGS. 2 and 3, the second magnet 140 may be configured on one or more surfaces of the receiving portion 122.

The second magnet 140 is configured to have a channel shape with a base portion and opposing side walls that extend from opposing sides of the base portion. As shown in FIG. 4, the second magnet 140 is configured with a generally rectangular parallelepiped slot or channel that receives the generally rectangular parallelepiped first magnet 130 therein. Accordingly, the second magnet 140 has a generally horseshoe-shaped, C-shaped or sideways U-shaped cross-sectional shape. However, the second magnet 140 may be configured otherwise relative to the configuration and shape of the first magnet 130. For example, if the first magnet 130 has cylindrical shape, at least a portion of the inner shape of the second magnet 140 may be a circular arc for receiving the first magnet 130. As can be appreciated, the first magnet 130 cooperates with the second magnet 140 to facilitate a sliding operation of the slider members 120, 130.

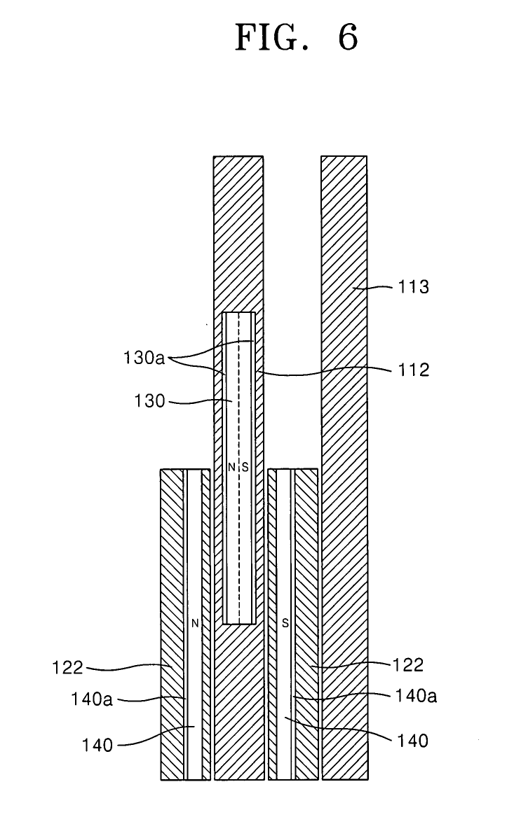

While the second magnet 140 has the length equal to the length of the second slider member 120 in FIG. 6, the present embodiment is not limited thereto. That is, the second magnet 140 may be shorter than the second slider member 120.

The second magnet 140 is arranged so that the N pole and the S pole thereof may correspond to an upper part and a lower part respectively as illustrated in FIGS. 3 and 4. Thus, the second magnet 140 is arranged so that a repelling force acts with respect to the first magnet 130, which aids a sliding operation.

The first magnet 130 and the second magnet 140 are arranged so that a perpendicular imaginary line, which connects the opposing side wall surfaces of second magnet 140 that face each other, passes at least a part of the first magnet 130 throughout the substantially entirety of the sliding operation. That is, even when the second slider member 120 is moved to its end positions (i.e., the initial and final positions), generally planar top and bottom surfaces of the first magnet unit 130 overlap with generally planar top and bottom side wall surfaces of the second magnet unit 140. In this sliding structure 100, a repelling force acts between the first magnet 130 and the second magnet 140. Accordingly, friction is minimized when the second slider member 120, which includes the second magnet 140, slides on the first slider member 110, which includes the first magnet 130, since the second slider member 120 is elevated above a surface of the first slider member 110 due to a repelling force. In such case, the elevation may be proportional to the repelling magnetic force, and more particularly, to the size and property of the magnets being used.

According to the current embodiment of the present invention, although the first magnet 130 and the second magnet 140 are arranged so that the perpendicular imaginary line, which connects the facing surfaces of the second magnet 140, passes at least the part of the first magnet 130 throughout the entire sliding operation, the present invention is not limited thereto. That is, the perpendicular imaginary line may not pass through the first magnet 130. For example, if the length of the first magnet 130 or the length of the second magnet 140 were shorter, then the imaginary line may not pass through the magnet units 130, 140 such as when the second slider member 120 is oriented one of its end positions (i.e., the initial and final positions). However, in such case, the first magnet 130 and the second magnet 140 may be arranged at a smaller distance from each other so that a repelling force generated between the first magnet 130 and the second magnet 140 increases in order to decrease sliding friction.

As shown in FIGS. 3 and 4, a magnetic shield 140a may be configured on an outer surface (i.e., an upper surface, a lower surface and a side surface that connects the upper and lower surfaces) of the second magnet 140.

Since the material and function of the magnetic shield 140a are substantially similar as those of the magnetic shield 130a, a detailed description of the magnetic shield 140a will not be repeated.

Although the magnetic shield 140a is configured on one or more outer surfaces of the second magnet 140 as shown, the present invention is not limited thereto. That is, the magnetic shield 140a may be configured in a part of the receiving portion 122 that receives the second magnet 140 (i.e., on one or more inner surfaces) or end surfaces. In some instances, the magnetic shield 140a may be configured on one or more surfaces of the receiving portion 122 that define the receiving groove 123, and then the second magnet 140 may be disposed in the receiving portion 122.

While the first slider member 110 is longer than the second slider member 120 in FIG. 2, the present embodiment is not limited thereto. That is, the first slider member 110 may be shorter than the second slider member 120.

When the sliding structure 100 configured as described above is used in a mobile electronic device (e.g., such as a mobile phone, a camera, a portable multimedia player (PMP), etc.) the sliding operation is performed in such a manner that one of the first slider member 110 and the second slider member 120 is embedded in a main body of the device (e.g., in which electrical components, such as batteries, or main chipsets of the electronic device are integrated), whereas the other one of the first slider member 110 and the second slider member 120 is embedded in a sub body of the device (e.g., a portion having a relatively simple structure). When the sliding structure 100 having the above structure is used in a portable electronic device, an occupied area and installation costs can be reduced.

In addition, one of the first slider member 110 and the second slider member 120 may be integrally formed with the primary body, and the other of the first slider member 110 and second slider member 120 may be integrally formed with the secondary body. In such case, a thin electronic device, which can smoothly perform a sliding operation, can be obtained.

Hereinafter, example operations of the sliding structure 100 will be described.

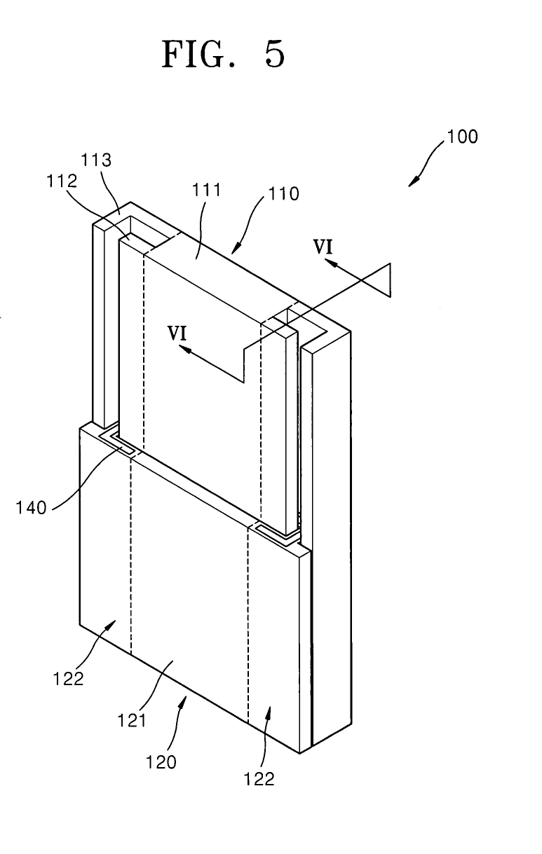

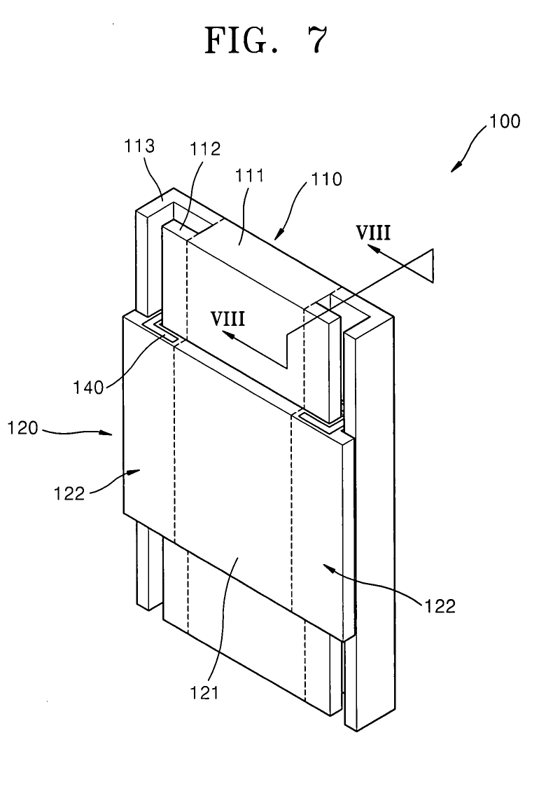

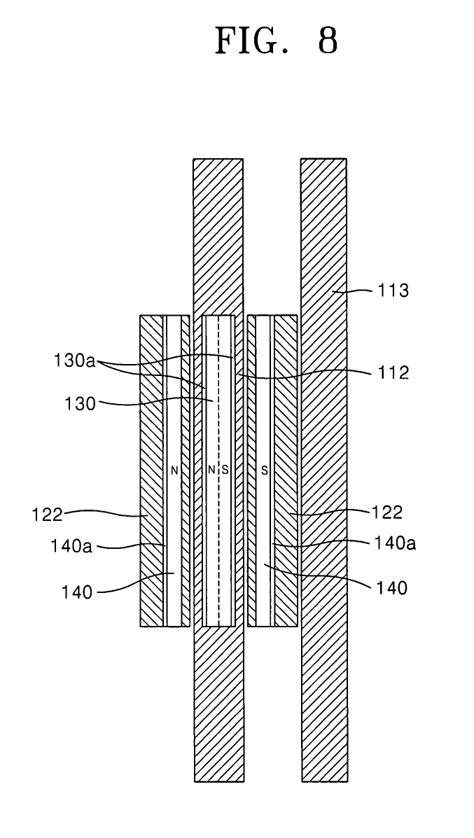

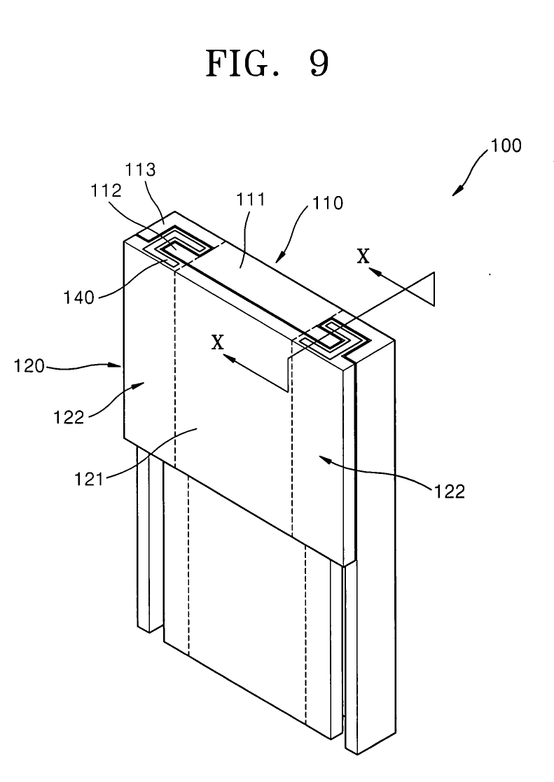

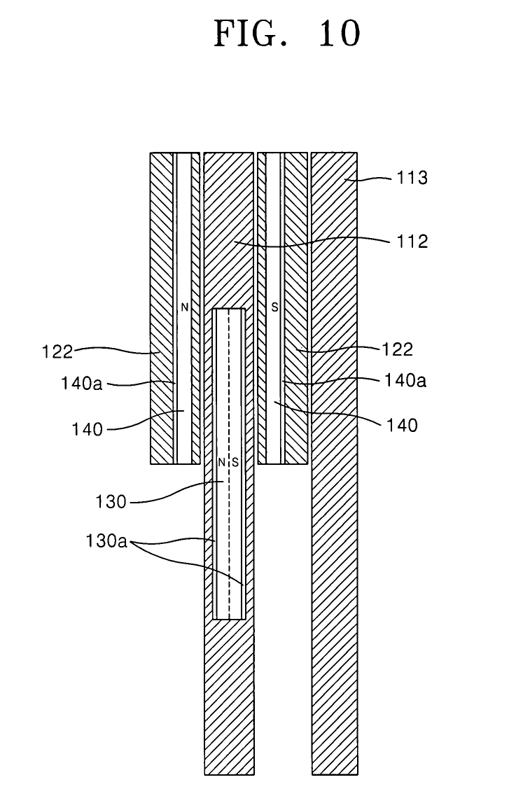

FIG. 5 is a perspective view illustrating that the second slider member 120 is disposed at an initial position. FIG. 6 is a cross-sectional view taken along line VI-VI of FIG. 5. FIG. 7 is a perspective view illustrating that the second slider member 120 is disposed at an intermediate position. FIG. 8 is a cross-sectional view taken along line VIII-VIII of FIG. 7. FIG. 9 is a perspective view illustrating that the second slider member 120 is disposed at a final position. FIG. 10 is a cross-sectional view taken along line X-X of FIG. 9. Although the terms initial and final are used herein, it should be appreciated that these are used for convenience of description and are not meant to be limiting to the operation of the present sliding structure 100. Indeed, it should be appreciated that the initial and final positions or orientations discussed hereinafter may be reversed.

FIGS. 5 and 6 illustrate the case where the second slider member 120 is in a start position. Referring to FIGS. 5 and 6, the second slider member 120 is disposed in a lower part of the first slider member 110.

As illustrated in FIG. 6, a part (e.g., approximately one half of the entire length) of the first magnet 130 is disposed between the N and S poles of the second magnet 140. Thus, a repelling force acts between the second magnet 140 and the first magnet 130 due to the arrangement of magnetic poles (i.e., polarities) of the second magnet 140 and the first magnet 130.

Accordingly, the second slider member 120 may be stably disposed in the start position by the repelling force. In addition, since the second slider member 120 somewhat elevated above the first slider member 110, friction can be reduced in the sliding operation.

When a user pushes up the second slider member 120 from the initial position of FIGS. 5 and 6, the second magnet 140 moves upward until a substantial portion of the length of the first magnet 130 becomes disposed between the N and S poles of the second magnet 140 (see FIG. 8). Accordingly, a repelling force between the second magnet 140 and the first magnet 130 is gradually increased.

In such case, although the user may push up the second slider member 120 quickly or with too much force, the repelling force generated between the second magnet 140 and the first magnet 130 prevents the second slider member 120 from moving suddenly. Accordingly, an impact on the sliding structure 100 can be prevented or substantially minimized. In addition, since the second slider member 120 is elevated from the first slider member 110 due to the repelling force, friction can be reduced in the sliding operation.

When the user continues to slide the second slider member 120 up from the initial position, the second slider member 120 of the sliding structure 100 reaches an intermediate state as shown in FIGS. 7 and 8.

Referring to FIG. 8, since substantially an entire length of the first magnet 130 is disposed between the N and S poles of the second magnet 140, one can appreciate that a strong repelling force is generated between the second magnet 140 and the first magnet 130.

When the user continually pushes up the second slider member 120 in the position illustrated in FIGS. 7 and 8, although the pushing force is not strong, the second slider member 120 can be pushed up due to the repelling force generated between the second magnet 140 and the first magnet 130. This repelling force facilitates moving the second slider member 120 from the intermediate position toward the initial and final positions.

In such case, an excessive impact on the second slider member 120 can be prevented. In addition, since the second slider member 120 is elevated from the first slider member 110 due to the repelling force, friction can be reduced in the sliding operation.

When the user continues to slide the second slider member 120 up, the second slider member 120 of the sliding structure 100 reaches a final position as shown in FIGS. 9 and 10

In FIGS. 9 and 10, a repelling force is generated between the first magnet 130 and the second magnet 140 due to the arrangement of the magnetic poles (i.e., polarity) of the second magnet 140 and first magnet 130.

Due to the repelling force, the second slider member 120 can be stably disposed or positively held at the final position. Furthermore, the second slider member 120 is somewhat elevated from the first slider member 110, thereby reducing a friction when the user slides the second slider member 120 down again.

As previously mentioned, although the second slider member 120 is slid up from an initial position to a final position as illustrated in FIGS. 5 through 10, the present embodiment is not limited thereto. That is, the second slider member 120 may be slid down from an initial position being the final position of FIGS. 9 and 10 to a final position being the initial position of FIGS. 5 and 6.

Since the sliding structure 100 is configured as described above, excessive impacts, which may occur during the sliding operation, can be avoided or substantially minimized.

Since the sliding structure 100 can be easily manufactured by integrally forming one of the first slider member 110 and the second slider member 120 with the primary body (or housing) of an electronic device, and the other of the first slider member 110 and the second slider member 120 with the secondary body of the device, a thin electronic device can be manufactured.

In the sliding structure 100 having the above structure, friction can be reduced in the sliding operation, and thus a user can easily operate an electronic device including the sliding structure 100.

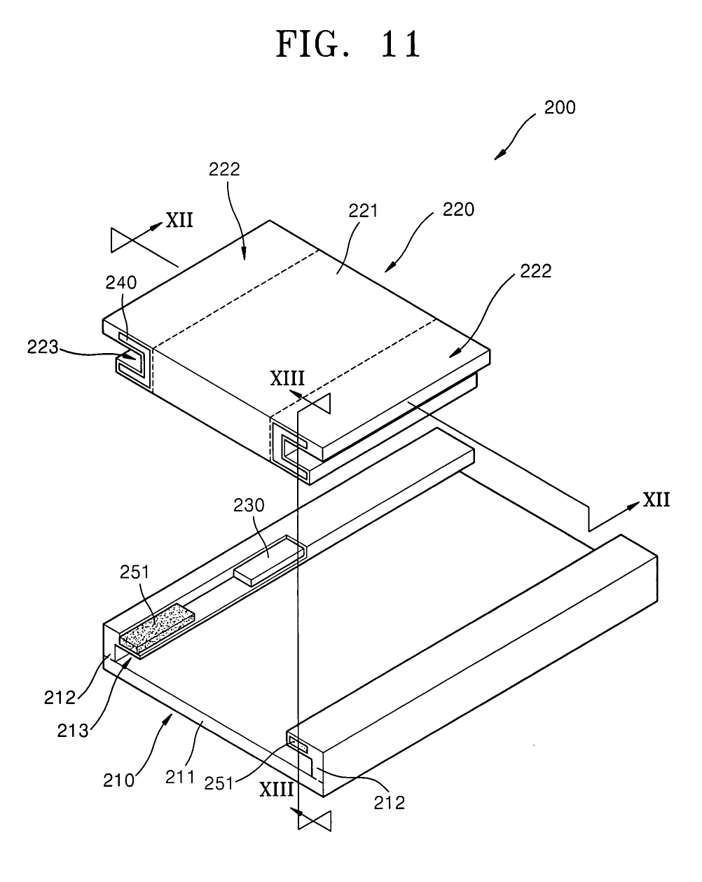

Hereinafter, referring to FIGS. 11 through 14, a sliding structure 200 according to another embodiment of the present invention will be described.

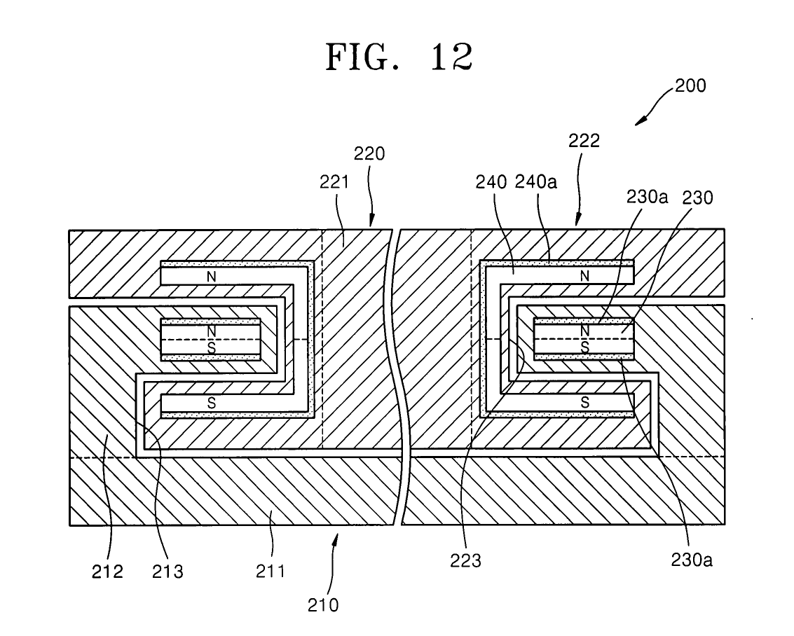

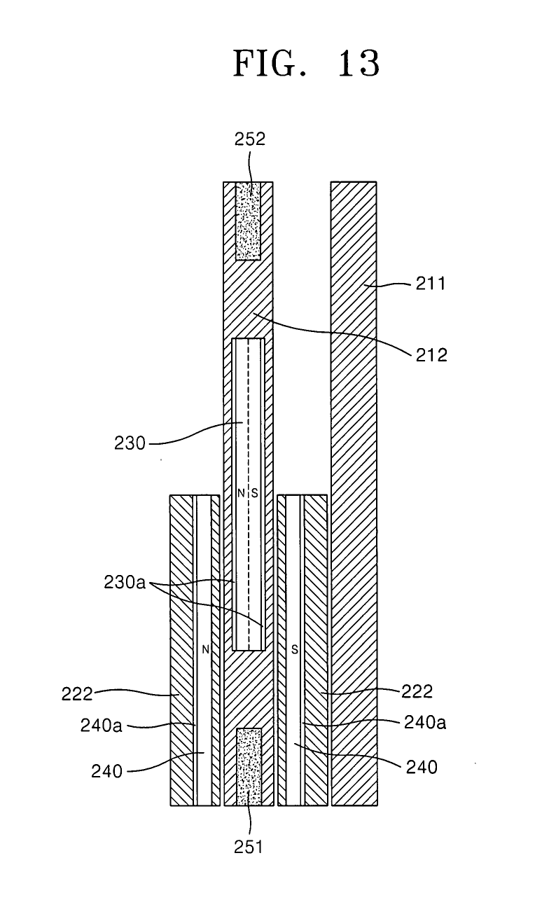

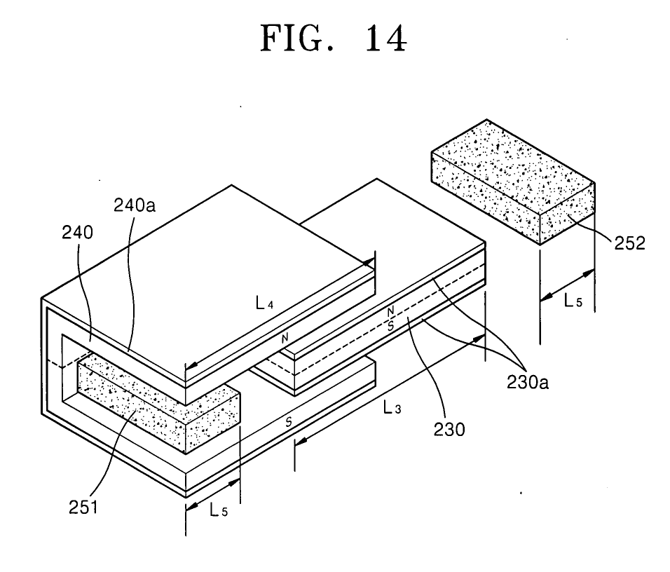

FIG. 11 is a partially-exploded perspective view illustrating a sliding structure 200, according to another embodiment of the present invention. FIG. 12 is a cross-sectional view of the sliding structure 200 taken along line XII-XII of FIG. 11. FIG. 13 is a cross-sectional view of the sliding structure 200 taken along line XIII-XIII of FIG. 11. FIG. 14 is an exploded perspective view illustrating an example arrangement of a first magnet and a second magnet of the sliding structure 200 of FIG. 11.

Referring to FIGS. 11 and 12, the sliding structure 200 includes a first slider member 210 with a first magnet 230, and a second slider member 220 with a second magnet 240.

The first slider member 210 may be formed of a non-magnetic material (e.g., synthetic resin, plastic, aluminium, etc.) and includes a support portion 211 and guide portions 212.

The support portion 211 has a generally planar shape. The guide portions 212 extend from both sides of the support portion 211.

The guide portions 212 include a bottom portion that extends perpendicularly upward from a top surface of the support portion 211 and a top portion that extends inward from the first portion and generally parallel with the support portion 211 such that the guide portions 212 have generally L-shaped cross-sections. A first receiving groove 213 is defined between the top portion of the guide portion 212 and the support portion 211.

The second slider member 220 may be formed of a non-magnetic material (e.g., aluminium alloy, synthetic resin, plastic, etc.) and includes a base portion 221 and receiving portions 222. The first and second slider members 210, 220 may be made of the same or different materials.

The base portion 221 has a generally rectangular parallelepiped shape. The receiving portions 222 extend from both sides of the base portion 221. As with the first embodiment 100 of the sliding structure, the guide portions 212 the receiving portions 222 are configured to have complementary shapes to facilitate slidable mating of the first and second slider members 210, 220.

The receiving portions 222 each include a first receiving portion with an upper surface that is generally coplanar with an upper surface of the base portion 221, a second receiving portion with a lower surface that is generally coplanar with a lower surface of the base portion 221, and a connecting portion that is generally perpendicular to the first and second receiving portions for connecting the portions. Accordingly, the receiving portion 222 has a generally C-shaped, horseshoe-shaped or sideways U-shaped cross-section such that a second receiving groove 223 is defined inside the receiving portion 222. When the sliding structure 200 is assembled, the guide portion 212 is inserted into the second receiving groove 223.

Furthermore, a part of the receiving portion 222 is inserted into the first receiving groove 213 when the sliding structure 200 is assembled.

The first magnet 230 is coupled with the guide portion 212, and the second magnet 240 is coupled with the receiving portion 222.

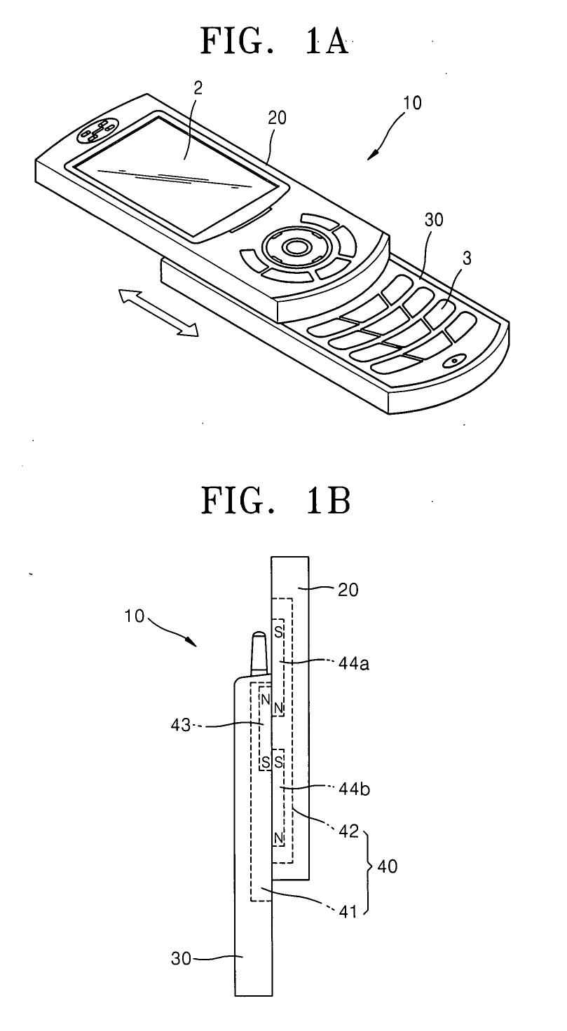

The first magnet 230 of FIGS. 11 through 14 may have a substantially similar structure as the first magnet 130 of FIGS. 1 through 10. That is, the first magnet 230 may be identical to the first magnet 130 in shape, location/configuration relative to the ends of the guide portions 112, 212 and the direction and order of magnetic poles (i.e., polarity).

Furthermore, referring to FIGS. 11, 13 and 14, at least one ferric or ferromagnetic member (e.g., a pair of ferromagnetic members 251 and 252 as shown) may be coupled with the guide portion 212 in a spaced-away relation to the first magnet unit 230. As shown in FIGS. 13 and 14, the first magnet unit 230 may be configured in a generally central portion of the guide portion 212 such that the first magnet unit 230 is between the ferromagnetic members 251 and 252.

The ferromagnetic members 251 and 252 are formed of ferromagnetic materials such as iron and have a generally rectangular parallelepiped shape. The ferromagnetic members 251 and 252 are spaced apart from the first magnet 230 by a predetermined distance. Although the members 251, 252 are illustrated as being substantially similarly spaced apart from the first magnet unit 230, one or both of the members 251, 252 may be further from or closer to the first magnet unit 230.

Although two ferromagnetic members 251 and 252 are shown in FIGS. 11 through 14, the present embodiment is not limited thereto. That is, the sliding structure 200 may include fewer or additional ferromagnetic members 251 and 252 as desired. For example, a single ferromagnetic member may be disposed on a side of the first magnet unit 230 (e.g., proximate to the initial or final position of second slider member 220), or three or more ferromagnetic members may be disposed on one or both sides of the first magnet unit 230. Indeed, it should be appreciated that the at least one ferromagnetic member may have various configurations.

As shown in FIG. 14, the ferromagnetic members 251 and 252 have the same length L₅, which may be shorter than the length L₃ of the first magnet 230. However, the present invention is not limited thereto. That is, the length L₅ of the ferromagnetic member may be longer or equal to the length L₃ of the first magnet 230.

In some instances, the ferromagnetic members 251 and 252 may help to positively hold the second sliding member 220 in one or more of the final and initial positions. Furthermore, since the second magnet units 241 and 242 may be attracted to the ferromagnetic members 251 and 252 (relative to the configuration of the members 251, 252 and an orientation of the second magnet 240), a sliding operation can be facilitated.

The second magnet 240 may have a substantially similar structure as the second magnet unit 140 of FIGS. 2 through 10. That is, the second magnet 240 may be identical to the second magnet 140 in shape, and the direction and order of magnetic poles.

Although the length L₄ of the second magnet 240 may be substantially similar to the length L₃ of the first magnet 230 as shown in FIG. 14, the present embodiment is not limited thereto. That is, the length L₄ of the second magnet 240 may be longer or equal to the length L₃ of the first magnet 230.

As shown in FIGS. 12-14, a magnetic shield 230a may be configured on upper and lower surfaces of the first magnet 230, and a magnetic shield 240a may be configured on upper, lower, and side surfaces (i.e., an outer surface) of the second magnet 240.

The magnetic shield 230a and the magnetic shield 240a may each be formed of a ferromagnetic substance to shield magnetic force lines respectively generated by the first magnet 230 and the second magnet 240. Furthermore, magnetic shields 230a and 240a may be configured on other surfaces of the first and second magnets 230, 240 such as side surfaces, end surfaces and an inner surface of the second magnet 240. In addition, the magnetic shield 230a and the magnetic shield 240a may be each formed of an AD-MU alloy or the like.

In the sliding structure 200 having the above structure, one of the first slider member 210 and the second slider member 220 may be embedded in a primary body of an electronic device (e.g., in which a main chip set of an electronic device such as a cellular phone, a camera, a PMP or the like, and an electrical portion such as a battery are integrated), whereas the other one of the first slider member 210 and the second slider member 220 may be embedded in a secondary body of the electronic device (e.g., a portion of the device having a relatively simple structure).

In addition, the sliding structure 200 may be manufactured by integrally forming one of the first slider member 210 and the second slider member 220 with the primary body, and the other of the first slider member 210 and the second slider member 220 with the secondary body. In such case, a thin electronic device, which can smoothly perform a sliding operation, can be realized.

Since the operation of the sliding structure 200 of FIGS. 11 through 14 is substantially similar to the operation the sliding structure 100 of FIGS. 2 through 10, descriptions thereof have not been repeated.

However, since the ferromagnetic members 251 and 252 are used, the second slider member 220 can be moved more stably and positively held at an initial position and a final position due to the attraction force between the second magnet 240 and each of the ferromagnetic members 251 and 252. That is, with the ferromagnetic members 251 and 252 being disposed at opposite ends of the length of the first slider member 210, the second magnet unit 240 becomes attracted to the initial and final positions.

Also, the sliding operation of the second slider member 220 can be more easily performed due to the attraction force between the second magnet 240 and each of the ferromagnetic substance members 251 and 252. For example, when the second slider member 220 is pushed up from an intermediate position to the final position, an attraction force is generated between the second magnet 240 and the ferromagnetic substance member 252 in addition to the repelling force generated between the second magnet 240 and the first magnet 230, and thus, although a user slightly pushes the second slider member 220, the second slider member 220 is easily pushed up.

As the structure, operation, and effect of the sliding structure 200 other than described herein are substantially similar as the structure, operation, and effect of the sliding structure 100, descriptions thereof have not been repeated.

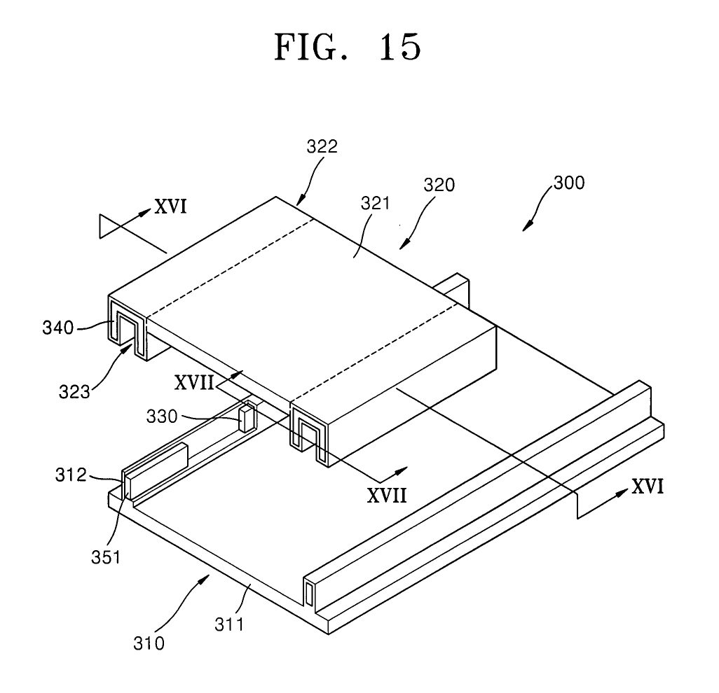

Hereinafter, referring to FIGS. 15 through 18, a sliding structure 300 according to yet another embodiment of the present invention will be described.

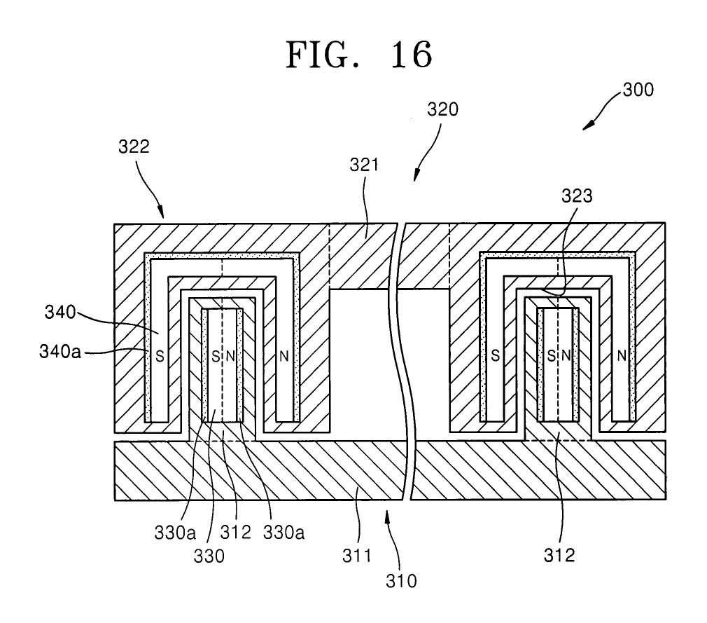

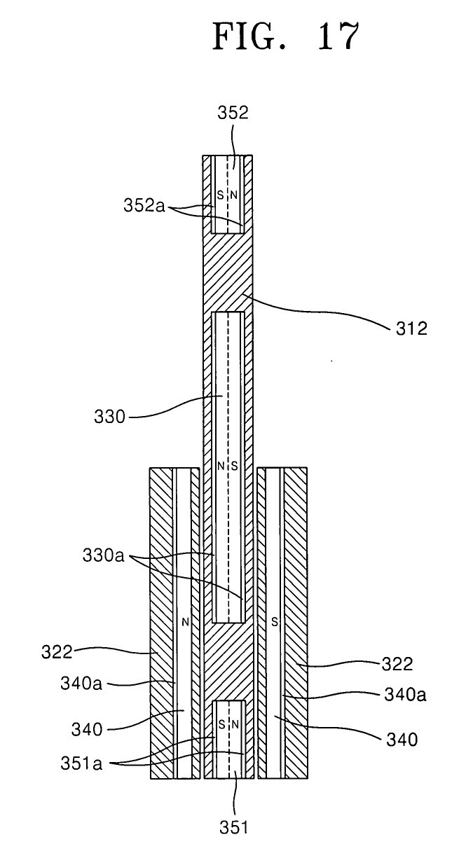

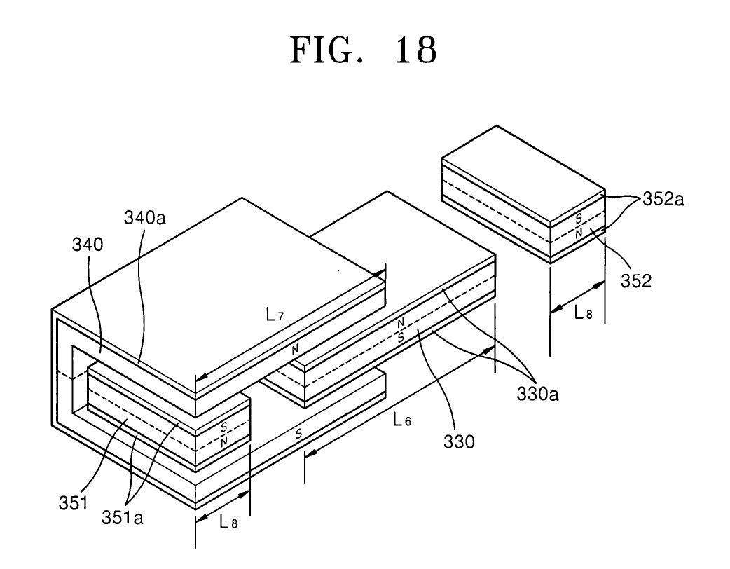

FIG. 15 is a partially-exploded perspective view illustrating the sliding structure 300, according to yet another embodiment of the present invention. FIG. 16 is a cross-sectional view of the sliding structure 300 taken along line XVI-XVI of FIG. 15. FIG. 17 is a cross-sectional view of the sliding structure 300 taken along line XVII-XVII of FIG. 15. FIG. 18 is a schematic perspective view illustrating an arrangement of a first magnet 330 and a second magnet 340 in the sliding structure 300 of FIG. 15.

Referring to FIGS. 15 through 18, the sliding structure 300 includes a first slider member 310 with a first magnet 330, and a second slider member 320 with a second magnet 340.

The first slider member 310 may be formed of a non-magnetic material (e.g., synthetic resin, plastic, aluminium, etc.) and includes a support portion 311 and guide portions 312.

The support portion 311 has a generally planar shape, and guide portions 312 are formed near both edges of the support portion 311.

The guide portion 312 has the shape of an upstanding rectangular pillar, a rail or a beam that extends substantially an entire length of the support portion 311. The first magnet 330 is coupled with the guide portion 312.

The second slider member 320 is formed of a non-magnetic material (e.g., synthetic resin, plastic, aluminium, etc.), and includes a base portion 321 and receiving portions 322.

The base portion 321 has a generally planar shape. Receiving portions 322 extend generally outward and downward from both side edges of the base portion 321. As with the first and second embodiments 100, 200 of the sliding structure, the guide portions 312 and the receiving portions 322 are configured to have complementary shapes to facilitate slidable mating of the first and second slider members 310, 320.

The receiving portion 322 has an upside-down, U-shaped cross-section.

A receiving groove 323 is defined in the receiving portion 322. The guide portion 312 is inserted into the receiving groove 323 when the sliding structure 300 is assembled.

The first magnet 330 is configured in the guide portion 312 as shown in FIGS. 16 and 17. However, the first magnet 330 may be configured on an outside surface of the guide portion 312. The second magnet 340 is configured in the receiving portion 322. However, the second magnet 340 may be configured on an outside surface of the receiving portion 322.

The first magnet 330 has substantially similar structure to that of the first magnet 130 described with respect to FIGS. 2 and 3. That is, the first magnet 330 may have the same shape as the first magnet 130, and the arrangement of the magnetic poles as the first magnet 130.

As illustrated in FIGS. 15, 17, and 18, a pair of attraction members being edge magnets 351 and 352 may be disposed in the guide portion 312. Although the attraction members are shown as magnets 351, 352, the attraction members may alternatively or additionally be ferric or ferromagnetic members (e.g., the members 251, 252 of sliding structure 200 shown in FIGS. 11-14).

The edge magnets 351 and 352 may have a generally rectangular parallelepiped shape and be permanent magnets. As shown in FIG. 17, the edge magnets 351 and 352 are each spaced from the first magnet 330 by a predetermined distance. Although the members 351, 352 are illustrated as being substantially similarly spaced apart from the first magnet unit 330, one or both of the members 351, 352 may be further from or closer to the first magnet unit 330.

Although the pair of the edge magnets 351 and 352 is shown and described, the present embodiment is not limited thereto. That is, only one of the edge magnets 351, 352 may be disposed in one side of the first magnet 330, or three or more edge magnets may be disposed in one side or both sides of the first magnet 330.

As shown in FIG. 18, the edge magnets 351 and 352 have the same length L₈, and the length L₈ may be smaller than a length L₆ of the first magnet 330. However, the present embodiment is not limited thereto. That is, the length L₈ may be larger than the length L₆ of the first magnet 330.

In some instances, the edge magnets 351 and 352 may facilitate a stable sliding operation and positive holding of the second slider member 320. That is, the magnetic poles of the first magnet 330 are arranged in the order opposite to that of the magnetic poles of the edge magnets 351 and 352, and an attraction force acts between the second magnet 340 and each of the edge magnets 351 and 352. Accordingly, a stable operation can be realized.

As shown, the edge magnets 351 and 352 may be configured with magnetic shields 351a and 352a, respectively on their top and bottom surfaces. The magnetic shields 351a and 352a may be formed of AD-MU alloy or the like. Furthermore, the edge magnets 351, 352 may be configured with shields on other surfaces such as end surfaces, side surfaces, etc.

The second magnet 340 has a substantially similar structure as that of the second magnet 140, but the second magnet 340 is rotated about an axis parallel to a length of the magnet 340 such that magnet 340 is about ninety degrees different in orientation from magnet 140. Furthermore, the second magnet 340 may have the same shape and the same arrangement of magnet poles as the second magnet 140.

Although a length L₇ of the second magnet 340 may be equal to the length L₆ of the first magnet 330, the present invention is not limited thereto. That is, the length L₇ of the second magnet 340 may be longer or smaller than the length L₆ of the first magnet 330.

Referring to FIGS. 16 and 18, a magnetic shield 330a may be configured on the first magnet 330, and a magnetic shield 340a may be configured on the second magnet 340.

The magnetic shield 330a and the magnetic shield 340a may be formed of a ferromagnetic substance to shield magnetic lines generated by the first magnet 330 and the second magnet 340. The magnetic shield 330a and the magnetic shield 340a may be formed of AD-MU alloy or the like.

In the sliding structure 300 having the above structure, one of the first slider member 310 and the second slider member 320 may be embedded in a primary body of an electronic device in which a main chip set of an electronic device such as a cellular phone, a camera, a PMP or the like, and an electrical portion such as a battery are integrated, whereas the other one of the first slider member 310 and the second slider member 320 may be embedded in a secondary body of the device having a relatively simple structure.

In addition, the sliding structure 300 may be manufactured by integrally forming one of the first slider member 310 and the second slider member 320 with the primary body, and by integrally forming the other one of the first slider member 310 and the second slider member 320 with the secondary body. In such case, a thin electronic device can be realized.

The sliding operation of the sliding structure 300 is similar to the sliding operation of the sliding structures 100, 200.

However, because of the edge magnets 351 and 352, the second slider member 320 can be more stably moved (as is the case also in the sliding structure 200 with the ferromagnetic members 251, 252) due to an attraction force between the second magnet 340 and each of the edge magnets 351 and 352 in a start position and an end position. For example, when the second slider member 320 is pushed up from an intermediate position to the final position, the attraction force is generated between the second magnet 340 and the edge magnet 352 in addition to the repelling force generated between the second magnet 340 and the first magnet 330, and thus a user can easily push up the second slider member 320.

As described above, since the sliding structure 300 includes the first magnet 330 and the second magnet 340 configured in a horizontal direction, the structure of the sliding structure 300 is simple, and the inner space of the sliding structure 300 can be increased to be efficiently used.

In addition, since the sliding structure 300 includes the edge magnets 351 and 352, a sliding operation is easily performed due to the attraction force between the second magnet 340 and each of the edge magnets 351 and 352.

As the structure, operation, and effect of the sliding structure other than described herein are the same as the structure, operation, and effect of the sliding structures 100, 200, descriptions thereof have not been repeated.

According to the sliding structure of the present invention, a thin electronic device can be realized, and friction and a force for handling the sliding structure can be reduced when a user is manipulating the electronic device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetic levitation sliding structure comprising:
a first slider member having a first end and a second end, a first length being defined by a distance between the first and second ends, the first slider member including a guide portion that extends at least a portion of the first length;
a first magnet coupled with the guide portion, the first magnet being spaced away from both of the first end and the second end;
a second slider member having a second length, the second slider member including a receiving portion that extends at least a portion of the second length and has a complementary shape to the guide portion for slidably mating with the guide portion; and
a channel-shaped second magnet coupled with the receiving portion, wherein the first magnet is configured in the channel of the second magnet to levitate above surfaces of the channel for facilitating relative movement of the first and second slider members.

2. The sliding structure of claim 1 wherein the first magnet is configured in a central portion of the guide portion.

3. The sliding structure of claim 1 further comprising at least one attraction member coupled with the guide portion proximate to at least one of the first end and the second end.

4. The sliding structure of claim 3 wherein the at least one attraction member comprises at least one ferromagnetic member.

5. The sliding structure of claim 3 wherein the at least one attraction member comprises at least one magnet having a polarity that is opposite to a polarity of the first magnet.

6. The sliding structure of claim 3 wherein the at least one ferromagnetic member comprises:
a first attraction member configured proximate to one of the first end and the second end; and
a second attraction member configured proximate to the other one of the first end and the second end.

7. The sliding structure of claim 1 wherein the first magnet has magnet poles arranged in a direction perpendicular to a sliding direction.

8. The sliding structure of claim 1 further comprising at least one magnetic shield disposed in at least a portion of the receiving portion.

9. A magnetic levitation sliding structure for a portable electronic device including a first movable portion and a second movable portion, the magnetic levitation sliding structure comprising:
a first slider member connected to one of the first and second movable portions, the first slider member including a first end and a second end, wherein a distance between the first and second ends defines a first length, a guide portion that extends at least a portion of the first length, and a first magnet configured in the guide portion, the first magnet being spaced away from both of the first end and the second end; and
a second slider member connected to the other one of first and second movable second portions, the second slider member including a second length, a receiving portion that extends at least a portion of the second length and which has a complementary shape to the guide portion for slidably mating with the guide portion, and a channel-shaped second magnet configured in the receiving portion,
wherein the first magnet is configured between opposing side walls of the second magnet for facilitating relative movement of the first and second movable portions.

10. The sliding structure of claim 9 wherein the first magnet is substantially enclosed in the guide portion and the second magnet is substantially enclosed in the receiving portion.

11. The sliding structure of claim 9 further comprising at least one attraction member coupled with the guide portion proximate to at least one of the first end and the second end.

12. The sliding structure of claim 11 wherein the at least one attraction member is substantially enclosed in the guide portion.

13. The sliding structure of claim 11 wherein the at least one attraction member comprises:
a first attraction member configured proximate to one of the first end and the second end; and
a second attraction member configured proximate to the other one of the first end and the second end.

14. The sliding structure of claim 9 wherein the first magnet has magnet poles arranged in a direction perpendicular to a sliding direction.

15. The sliding structure of claim 9 further comprising at least one magnetic shield disposed in at least a portion of the receiving portion.

16. The sliding structure of claim 11 wherein the at least one attraction member is selected from the group consisting of magnets, ferric members and ferromagnetic members.

17. A portable electronic device comprising:
a first slidably movable portion including a first slider member, the first slider member including a first length defined by a distance between a first end and a second end, a guide portion that extends at least a portion of the first length, and a first magnet configured in the guide portion, the first magnet being spaced away from both of the first end and the second end; and
a second slidably movable portion including a second slider member, the second slider member including a second length, a receiving portion that extends at least a portion of the second length and which has a complementary shape to the guide portion for slidably mating with the guide portion, and a channel-shaped second magnet configured in the receiving portion,
wherein the first magnet is configured in a channel of the channel-shaped second magnet for facilitating relative sliding movement of the first and second slidably movable portions.

18. The portable electronic device of claim 17 further comprising at least one attraction member coupled with the guide portion proximate to at least one of the first end and the second end.

19. The portable electronic device of claim 18 wherein the at least one attraction member comprises:
a first attraction member configured proximate to one of the first end and the second end; and
a second attraction member configured proximate to the other one of the first end and the second end.

20. The portable electronic device of claim 19 wherein the first attraction member is spaced away from a first end of the first magnet by a first predetermined distance, and wherein the second attraction member is spaced away from a second end of the first magnet by a second predetermined distance.
